(19) United States
(12) Patent Application Publication
(10) Pub. No.: US 2010/0259850 A1
(43) Pub. Date: Oct. 14, 2010

(54) STORAGE DEVICE AND METHOD OF DETERMINING HEAD SLIDER CONTACT

(75) Inventors: Koji MIYAKE, Hachioji-shi (JP); Tohru FUJIMAKI, Yokohama-shi (JP); Takahiro IMAMURA, Ome-shi (JP); Atsuo IIDA, Yamato-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/756,090

(22) Filed: Apr. 7, 2010

(30) Foreign Application Priority Data
Apr. 8, 2009 (JP) 2009-094077

(51) Int. Cl. G11B 5/60

(52) U.S. Cl. 360/234.7

(57) ABSTRACT

According to one embodiment, a storage device includes a recording medium, a head slider, a head suspension, an actuator, and an alternating current component generator. The head slider faces a surface of the recording medium. The head suspension supports the head slider. The actuator is incorporated in the head slider and increases the protruding length of a protrusion formed on the head slider toward the surface of the recording medium based on an increase in a supplied electrical signal. The alternating current component generator superimposes an alternating current component having a frequency equal to the natural frequency of the head suspension over the electrical signal while increasing or decreasing the protruding length of the protrusion at a predetermined amplitude.

### CROSS-REFERENCE TO RELATED APPLICATIONS

This application is based upon and claims the benefit of priority from Japanese Patent Application No. 2009-94077, filed Apr. 8, 2009, the entire contents of which are incorporated herein by reference.

### BACKGROUND

1. Field

One embodiment of the invention relates to a storage device, and more particularly, to a recording medium drive comprising an actuator configured to drive a write coil.

2. Description of the Related Art

There is a flying height variation of 2 to 3 nanometers between head sliders mounted on a hard disk drive (HDD). To prevent such a variation, zero calibration is conducted. In the zero calibration, a current is supplied to a heating wire embedded in a head slider while the head slider is kept floating. By the heat of the heating wire, an electromagnetic transducer device thermally expands. In this manner, the end of the electromagnetic transducer device comes gradually closer to a magnetic disk. Contact between the electromagnetic transducer device and the magnetic disk is then detected. In this manner, the protruding length of the electromagnetic transducer device upon contacting the magnetic disk is detected. Based on the detected length of the protrusion, the protruding length of the electromagnetic transducer device upon reading or writing is determined. Reference may be had to, for example, Japanese Patent Application Publication (KOKAI) Nos. 2003-308670 and H5-109058.

In the zero calibration, the end of the electromagnetic transducer device is brought into contact with the rotating magnetic disk. Upon making the contact, the head slider vibrates. The vibration is detected based on a change in a read signal of the electromagnetic transducer device or an acoustic emission (AE) sensor. As mentioned earlier, because the head slider is brought into contact with the magnetic disk locally at the end of the electromagnetic transducer device, the frictional force acting on the head slider is kept small. In particular, because a lubricant film is formed on the surface of the magnetic disk, the vibration of the head slider is suppressed. As a result, it is difficult to accurately detect an initial contact.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic plan view of an internal structure of a hard disk drive (HDD) as a storage device according to an embodiment of the present invention;

FIG. 2 is an exemplary schematic perspective view of a structure of a flying head slider in the embodiment;

FIG. 3 is an exemplary sectional view of a device incorporating film schematically illustrating a structure of an electromagnetic transducer device mounted on the flying head slider in the embodiment;

FIG. 4 is an exemplary sectional view of the device incorporating film schematically illustrating a protrusion formed on the flying head slider in the embodiment;

FIG. 5 is an exemplary schematic side view ally of a structure of a head suspension and a flexure in the embodiment;

FIG. 6 is an exemplary block diagram of a configuration of a control system of the HDD in the embodiment;

FIG. 7 is an exemplary partially-enlarged plan view of a magnetic disk as a specific example of a recording medium in the embodiment;

FIG. 8 is an exemplary schematic partially-enlarged plan view of a structure of a servo sector area in the embodiment;

FIG. 9 is an exemplary schematic diagram of an alternating current (AC) component in the embodiment;

FIG. 10 is an exemplary sectional view schematically illustrating the up-and-down movement of the protrusion in the embodiment;

FIG. 11 is an exemplary schematic graph of a change in drive current in the embodiment;

FIG. 12 is an exemplary schematic graph of a change in flying height in the embodiment;

FIG. 13 is an exemplary partially-enlarged plan view schematically illustrating a vibration of the head suspension in the embodiment;

FIG. 14 is an exemplary schematic diagram of an AC component according to another embodiment of the invention; and

FIG. 15 is an exemplary schematic diagram of an AC component according to still another embodiment of the invention.

### DETAILED DESCRIPTION

Various embodiments according to the invention will be described hereinafter with reference to the accompanying drawings. In general, according to one embodiment of the invention, a storage device comprises a recording medium, a head slider, a head suspension, an actuator, and an alternating current component generator. The head slider faces a surface of the recording medium. The head slider is configured to face a surface of the recording medium. The head suspension is configured to support the head slider. The actuator is configured to be incorporated in the head slider and increase the protruding length of a protrusion formed on the head slider toward the surface of the recording medium based on an increase in an electrical signal supplied. The alternating current component generator is configured to superimpose an alternating current component having a frequency equal to a natural frequency of the head suspension over the electrical signal while increasing or decreasing the protruding length of the protrusion at a predetermined amplitude.

According to another embodiment of the invention, there is provided a method of determining a head slider contact. The method comprises: boosting an electrical signal supplied to an actuator incorporated in a head slider to increase a protruding length of a protrusion formed on the head slider toward a recording medium; superimposing an alternating current component having a frequency equal to a natural frequency of a head suspension supporting the head slider over the electrical signal when the protruding length of the protrusion increases; and detecting contact between the protrusion and the recording medium based on a vibration of the head slider induced by the contact between the protrusion and the recording medium.

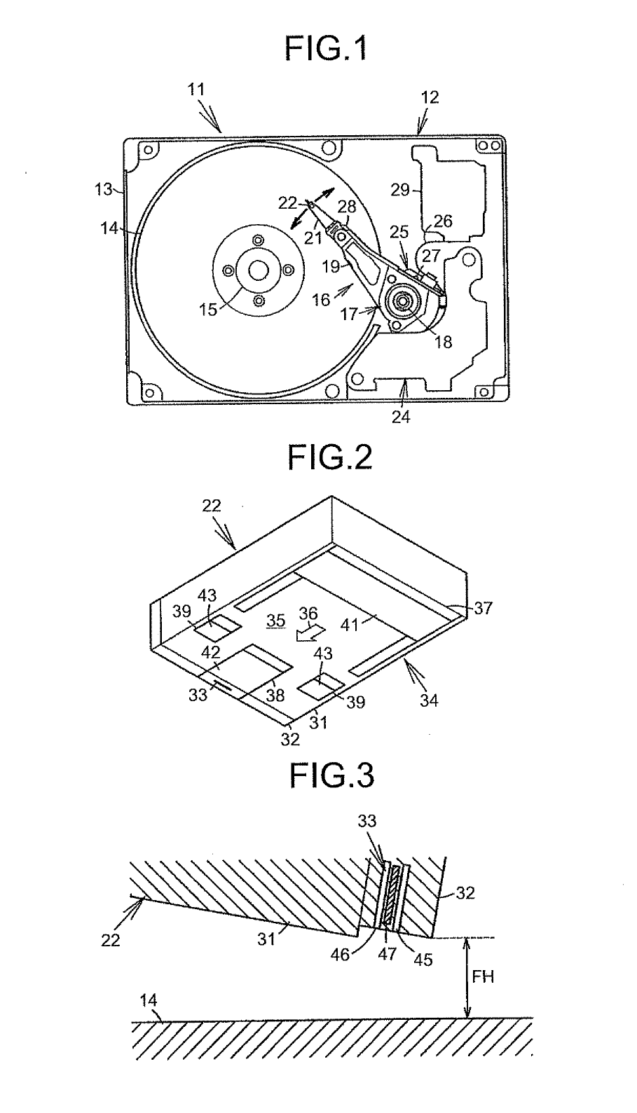

FIG. 1 schematically illustrates an internal structure of a hard disk drive (HDD) 11 as a specific example of a storage device according to an embodiment of the invention. The HDD 11 comprises a chassis, i.e., a housing 12. The housing 12 comprises a box-shaped base 13 and a cover (not illustrated). The base 13 defines, for example, a flat rectangular parallelepiped internal space, i.e., a housing space. The base 13 may be formed by casting a metallic material such as aluminum. The cover is connected to an opening of the base 13. The housing space is sealed between the cover and the base 13. The cover may be formed by, for example, pressing a sheet of plate.

In the housing space, at least one piece of magnetic disk 14 as a recording medium is housed. The magnetic disk 14 is mounted on the rotation axis of a spindle motor 15. The spindle motor 15 can rotate the magnetic disk 14 at a high speed of, for example, 5400 rpm, 7200 rpm, 10000 rpm, and 15000 rpm. In the embodiment, the magnetic disk 14 is described as a vertical magnetic recording disk. In other words, an axis of easy magnetization on the recording magnetic film is set in a direction perpendicular to the surface of the magnetic disk 14.

In the housing space, a carriage 16 is further housed. The carriage 16 comprises a carriage block 17. The carriage block 17 is rotatably connected to a shaft 18 extending in a vertical direction. With the carriage block 17, a plurality of carriage arms 19 horizontally extending from the shaft 18 is integrated. The carriage block 17 may be formed by, for example, extruding aluminum.

A head suspension 21 is attached to an end of each of the carriage arms 19. The head suspension 21 extends forward from the end of the carriage arm 19. A flexure, described later, is affixed on the end of the head suspension 21. The flexure functions to change the position of a flying head slider 22 with respect to the head suspension 21. An electromagnetic transducer device is mounted on the flying head slider 22.

When an air flow is produced on a surface of the magnetic disk 14 by the rotation of the magnetic disk 14, positive pressure, i.e., buoyancy, and negative pressure act on the flying head slider 22 by the action of the air flow. When the buoyancy, the negative pressure, and a pressing force of the head suspension 21 are balanced, the flying head slider 22 can be kept floating with relatively high stiffness while the magnetic disk 14 is rotating.

When the carriage 16 rotates about the shaft 18 while the flying head slider 22 is floating, the flying head slider 22 can move along a radius line of the magnetic disk 14. As a result, the electromagnetic transducer device on the flying head slider 22 can traverse a data zone between the innermost recording track and the outermost recording track. In this manner, the electromagnetic device on the flying head slider 22 is positioned on a targeted recording track.

A power source such as a voice coil motor (VCM) 24 is connected to the carriage block 17. The VCM 24 functions to rotate the carriage block 17 about the shaft 18. Such rotation of the carriage block 17 enables reciprocation of the carriage arm 19 and the head suspension 21.

As can be seen from FIG. 1, a flexible printed circuit board (FPC) 25 is arranged on the carriage block 17. The FPC 25 comprises a head integrated circuit (IC) 27 implemented on a flexible printed circuit board 26. The head IC 27 is connected to a read device and a write device arranged on the electromagnetic transducer device. To make the connections, a flexure 28 is used. The flexure 28 is connected to the FPC 25.

At the time of reading magnetic information that is binary information, a sense current is supplied from the head IC 27 to the read device on the electromagnetic transducer device. Similarly, at the time of writing binary information, a write current is supplied from the head IC 27 to the write device on the electromagnetic transducer device. The voltage of the sense current is set to a specified value. A compact circuit board 29 arranged in the housing space or a printed circuit board (not illustrated) attached on a rear side of a bottom plate of the base 13 supplies the current to the head IC 27.

FIG. 2 illustrates the flying head slider 22 of the embodiment. The flying head slider 22 comprises a slider body 31 that is formed in, for example, a flat rectangular parallelepiped shape. A device incorporating film 32 is layered on an air-outgoing end surface of the slider body 31. Embedded in the device incorporating film 32 is an electromagnetic transducer device 33, which will be described in details later. The slider body 31 may be formed with a hard non-magnetic material such as Al2O3-TiC (Al—TiC). The device incorporating film 32 may be formed with a relatively soft insulating non-magnetic material such as Al2O3 (almina).

A medium facing surface 34 of the slider body 31 faces the magnetic disk 14. A flat base surface 35 that is a reference surface is defined on the medium facing surface 34. When the magnetic disk 14 is rotating, an air flow 36 acts on the medium facing surface 34 in the direction from the front to the rear end of the slider body 31. The medium facing surface 34 is formed with a strip of front rail 37 standing out from the base surface 35 on the side upstream of the air flow 36, i.e., on an incoming end of the air. Similarly, the medium facing surface 34 is formed with a rear center rail 38 standing out from the base surface 35 on the side downstream of the air flow, i.e., on the outgoing end of the air. The rear center rail 38 is arranged at the center in the width direction of the slider. The medium facing surface 34 is formed with a pair of left and right rear side rails 39 and 39 standing out from the base surface 35 on the side at the outgoing end of the air.

Air bearing surfaces (ABS) 41, 42, and 43 are formed on the top surfaces of the front rail 37, the rear center rail 38, and the rear side rails 39 and 39, respectively. The air-incoming ends of the ABSs 41, 42, and 43 are stepped and connected to the stepped surfaces of the rails 37, 38, and 39, respectively. The medium facing surface 34 bears the air flow 36 produced by the rotation of the magnetic disk 14. At this time, because of these steps, relatively high positive pressure, i.e., buoyancy, is produced on the ABSs 41, 42, and 43. In addition, relatively high negative pressure is produced on the back that is the rear side of the front rail 37. Based on the balance between the buoyancy and the negative pressure, the flying head slider 22 is kept in the floating position.

As illustrated in FIG. 3, the electromagnetic transducer device 33 comprises a write device 45 and a read device 46. A thin film magnetic head is used for the write device 45. The thin film magnetic head generates a magnetic field by a thin-film coil pattern. This magnetic field enables binary information to be written to the magnetic disk 14. By contrast, a giant magneto-resistance (GMR) device or a tunnel magneto-resistance (TMR) device is used for the read device 46. On a GMR device or a TMR device, a resistance change corresponding to the direction of the magnetic field arising from the magnetic disk 14 is induced on a spin-valve film or a tunnel junction film. Based on such a resistance change, binary information is read from the magnetic disk 14. A protective film (not illustrated) is formed on the surface of the rear center rail 38. The protective film covers the write gap on the write device 45 or the read gap on the read device 46. Diamond-like carbon (DLC) may be used for the protective film.

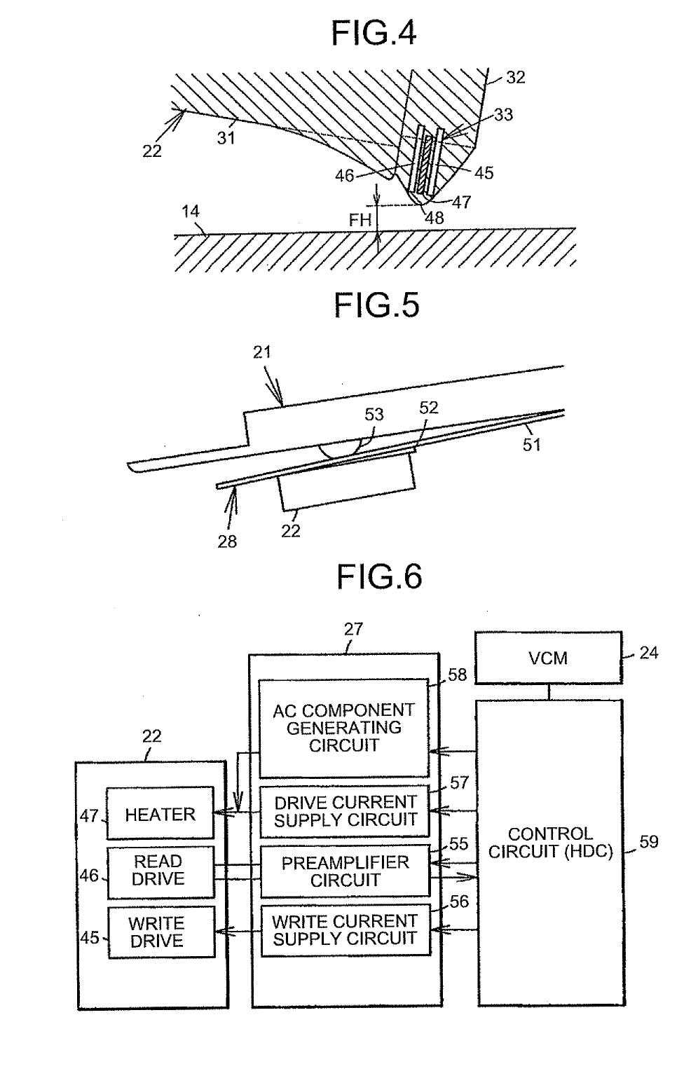

An actuator that is a heater 47 associated with the electromagnetic transducer device 33 is embedded in the device incorporating film 32. The heater 47 is formed with a heating wire. When power is supplied to the heater 47, the thin-film coil pattern in the write device 45 and the device incorporating film 32 expand due to the heat of the heater 47. As a result, as illustrated in FIG. 4, the surface of the device incorporating film 32 protrudes at the front end of the electromagnetic transducer device 33. In this manner, a protrusion 48 is formed. The write device 45 and the read device 46 are displaced toward the magnetic disk 14. The flying height FH of the electromagnetic transducer device 33 is adjusted correspondingly to the protruding length of the protrusion 48.

As illustrated in FIG. 5, the flexure 28 comprises a fixing plate 51 that is joined to the surface of the head suspension 21, and a supporting plate 52 that supports the flying head slider 22 on the surface thereof. The fixing plate 51 and the supporting plate 52 are formed with a sheet of leaf spring material. The leaf spring material may be made of, for example, stainless steel having a uniform thickness. The flying head slider 22 is adhered onto the surface of the supporting plate 52. The supporting plate 52 rests on a dome-shaped projection 53 located on the rear side of the flying head slider 22. The projection 53 is formed on the surface of the head suspension 21. The supporting plate 52, i.e., the flying head slider 22, can change the position thereof on the projection 53.

FIG. 6 schematically illustrates a configuration of a control system of the HDD 11. A preamplifier circuit 55 and a write current supply circuit 56 are embedded in the head IC 27. The preamplifier circuit 55 is connected to the read device 46. The sense current is supplied from the preamplifier circuit 55 to the read device 46. Binary information is detected based on the sense current. The voltage of the sense current is kept constant. The write current supply circuit 56 is connected to the write device 45. The write current is supplied from the write current supply circuit 56 to the write device 45. The write current supplied thereto produces a magnetic field in the write device 45. In this manner, binary information is written onto the magnetic disk 14.

A drive current supply circuit 57 is embedded in the head IC 27. The drive current supply circuit 57 is connected to the heater 47. The drive current supply circuit 57 supplies a DC component electrical signal, i.e., a drive current, to the heater 47. The heater 47 generates heat depending on the supplied drive current. The temperature of the heater 47 is determined by the amount of the current. An alternating current (AC) component generating circuit 58 connected to the drive current supply circuit 57 is also embedded in the head IC 27. The AC component generating circuit 58 superimposes an AC component over the drive current. The frequency of the AC component matches the natural frequency of the head suspension 21 in the in-plane direction. The natural frequency is in a bandwidth from several to several-ten kilohertz. When the AC component is superimposed over the drive current, the protrusion 48 moves up and down in a vertical direction perpendicular to the surface of the magnetic disk 14. As a result, the protruding length of the protrusion 48 varies within an extremely short time.

A control circuit 59 is a hard disk controller (HDC) connected to the head IC 27. The control circuit 59 instructs the head IC 27 to supply the sense current, the write current, the drive current, or the AC component. The control circuit 59 controls operations of the preamplifier circuit 55, the write current supply circuit 56, the drive current supply circuit 57, and the AC component generating circuit 58 according to a predetermined software program. The software program may be stored in a memory (not illustrated). The zero calibration, described later, is performed based on the software program. Data required for the zero calibration may also be stored in the memory. The software program and the data may be transferred to the memory from another storage device. The control circuit 59 and the memory are implemented on, for example, the circuit board 29. The control circuit 59 corresponds to a detector.

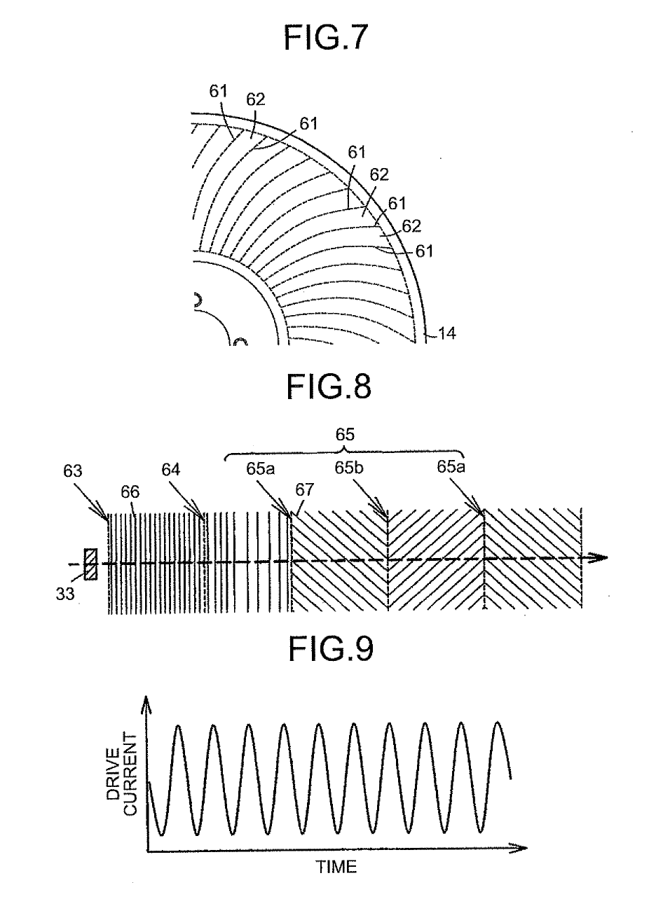

As illustrated in FIG. 7, a plurality of servo sector areas 61, each curving and extending along the radial direction of the magnetic disk 14, is formed on the front and the rear surfaces of the magnetic disk 14. The servo sector areas 61 are arranged equally spaced along the circumferential direction. A servo pattern is formed in the servo sector areas 61. The binary information written in the servo pattern is read by the electromagnetic transducer device 33. Based on the information read from the servo pattern, the flying head slider 22 is positioned in the radial direction of the magnetic disk 14.

Following the positioning, a circular recording track is formed. According to the radial displacement of the flying head slider 22, recording tracks are concentrically formed. The movement path of the electromagnetic transducer device 33 determines the degree of the curve of the servo sector area 61. Data areas 62 are reserved between the neighboring servo sector areas 61. The electromagnetic transducer device 33 follows a recording track within the data areas 62 at the position determined based on the servo pattern.

As illustrated in FIG. 8, each of the servo sector areas 61 is sectioned into a preamble field 63, a servo mark address field 64, and a phase-burst field 65 sequentially from upstream to downstream. In the preamble field 63, for example, a plurality of strips of magnetic patterns 66 extending along the radial direction of the magnetic disk 14 is formed. The magnetic patterns 66 are arranged equally spaced in the circumferential direction of the magnetic disk 14. The preamble field 63 ensures the synchronization of signals read from the read device 46. At the same time, a gain is adjusted based on the signals read from the read device 46. The “upstream” and “downstream” herein are defined with respect to the direction in which the flying head slider 22 runs during the rotation of the magnetic disk 14.

In the servo mark address field 64, magnetic dots are arranged in a specific pattern. The arrangement of the magnetic dots reflects a sector number or a track number. At the same time, in the servo mark address field 64, a plurality of strips of magnetic patterns extending in the radial direction of the magnetic disk 14 is formed. These magnetic patterns identify a servo clock signal. A phase, described later, is determined based on the servo clock signal. The function of the servo mark address field 64 enables a sector number or a track number to be determined. At the same time, the functions of the preamble field 63 and the servo mark address field 64 enable reference timing for the phase to be determined.

In the phase-burst field 65, a plurality of magnetic patterns, i.e., phase-burst lines 67, extending with a predetermined angle with respect to the radial direction of the magnetic disk 14 is formed. Upon forming the phase-burst lines 67, an even field 65a and an odd field 65b are arranged in an alternating manner in the phase-burst field 65. The even field 65a and the odd field 65b are used in pair. In the even field 65a, the further toward the inner side of the magnetic disk 14 the read device 46 traverses the phase-burst lines 67, the earlier the phase arrives. On the contrary, in the odd field 65b, the phase proceeds as the read device 46 that traverses the phase-burst lines 67 deviates to the outer side of the magnetic disk 14.

Upon tracking servo control, while the read device 46 sequentially traverses the preamble field 63, the servo mark address field 64, and the phase-burst field 65, the read device 46 outputs signals. When the read device 46 traverses the servo mark address field 64, the control circuit 59 generates a servo clock signal. When the read device 46 traverses the phase-burst field 65 next, the control circuit 59 collects a signal waveform for every pair of the even field 65a and the odd field 65b. The control circuit 59 then takes the average of the signal waveforms using the Fast Fourier Transform. The control circuit 59 calculates a phase difference for every pair of the even field 65a and the odd field 65b based on the servo clock signal and the signal waveforms. Based on the calculated phase difference, the control circuit 59 outputs a positioning error signal. The positioning error signal is supplied to the VCM 24 as a control signal.

The VCM 24 rotates the carriage 16 about the shaft 18 based on the positioning error signal. The electromagnetic transducer device 33 is positioned at a predetermined position in the radial direction of the magnetic disk 14. As a result, the electromagnetic transducer device 33 can reliably follow the targeted recording track. At this time, when the carriage 16 rotates about the shaft 18, the flying head slider 22 moves on the magnetic disk 14, following a virtual circle drawn with at the shaft 18 as the center. When the electromagnetic transducer device 33 is positioned at a recording track located approximately at the center between the innermost recording track and the outermost recording track, the angle at which the longitudinal center line of the slider body 31 crosses the center line of the recording track, i.e., the skew angle, is set to zero degree. The skew angle is set to a positive value on the outer side of the magnetic disk 14, and is set to a negative value on the inner side of the magnetic disk 14. When the electromagnetic transducer device 33 is positioned on the innermost or the outermost recording track, the skew angle is set to the minimum or the maximum value. At this time, the minimum or the maximum skew angle is set to, for example, approximately −15 degrees or +15 degrees. The absolute value of the skew angle increases from the center toward the outer or the inner side of the magnetic disk 14.

Before reading or writing binary information from or to the HDD 11, the protruding length of the protrusion 48 is set. To set the protruding length, zero calibration is performed. In the zero calibration, the protruding length of the protrusion 48 is measured when the protrusion 48 is brought into contact with the magnetic disk 14. The protruding length of the protrusion 48 in reading or writing operations is set based on the protruding length. Once the protruding length of the protrusion 48 in reading or writing operations is set, the electromagnetic transducer device 33 can be kept floating at a predetermined flying height FH over the surface of the magnetic disk 14. The zero calibration may be performed, for example, every time the HDD 11 is started up.

To perform zero calibration, the control circuit 59 executes a predetermined software program. When the software program is executed, the control circuit 59 performs initial settings to the HDD 11. The magnetic disk 14 rotates at a predetermined rotation speed. The control circuit 59 instructs the VCM 24 to start driving. The carriage 16 reciprocates about the shaft 18. As a result, the flying head slider 22 faces the surface of the magnetic disk 14. The flying head slider 22 is kept floating over the magnetic disk 14 at the predetermined flying height FH. At this time, the skew angle is set to the minimum or the maximum angle. The flying head slider 22 is positioned at the innermost or the outer most track on the magnetic disk 14. In addition, the control circuit 59 monitors the output of the preamplifier circuit 55. At this time, the drive current supply circuit 57 stops the supply of the drive current.

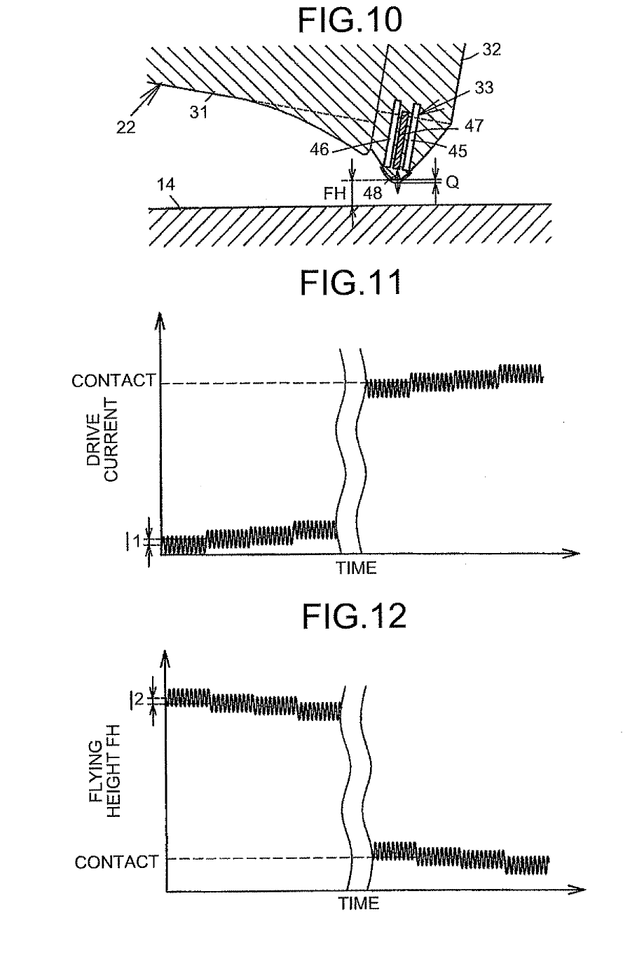

When the initial settings are completed, the control circuit 59 feeds an instruction signal to the drive current supply circuit 57 and the AC component generating circuit 58. The control circuit 59 increases the protruding length of the protrusion 48 by a specified length. In response to the instruction signal, the drive current supply circuit 57 supplies a drive current in an amount corresponding to the increased length to the heater 47. At this time, the AC component generating circuit 58 superimposes an AC component over the drive current having a direct current (DC) component output from the drive current supply circuit 57. As illustrated in FIG. 9, the AC component is defined by, for example, a sine wave. As illustrated in FIG. 10, the protrusion 48 moves up and down in the vertical direction perpendicular to the surface of the magnetic disk 14 based on the AC component. The displacement Q of the vertical movement is set according to the amplitude of the AC component. The AC component matches the natural frequency of the head suspension 21 in the in-plane direction.

After the protruding length of the protrusion 48 increases, the control circuit 59 determines the contact between the protrusion 48 and the magnetic disk 14. Upon the determination, the control circuit 59 monitors a change in the positioning error signal. Until any change in the positioning error signal is detected, the control circuit 59 keeps increasing the protruding length of the protrusion by a specified increased length. The increased length of the protrusion is preferably set smaller than the thickness of a lubricant film formed on the magnetic disk 14. As illustrated in FIG. 11, the drive current supplied to the heater 47 increases by a specified amount I1. As illustrated in FIG. 12, the protruding length of the protrusion 48 increases by a length 12 corresponding to the increased amount I1 in the drive current. According to the increase in the protruding length of the protrusion 48, the flying height FH decreases. As a result, the protrusion 48 is brought into contact with the magnetic disk 14.

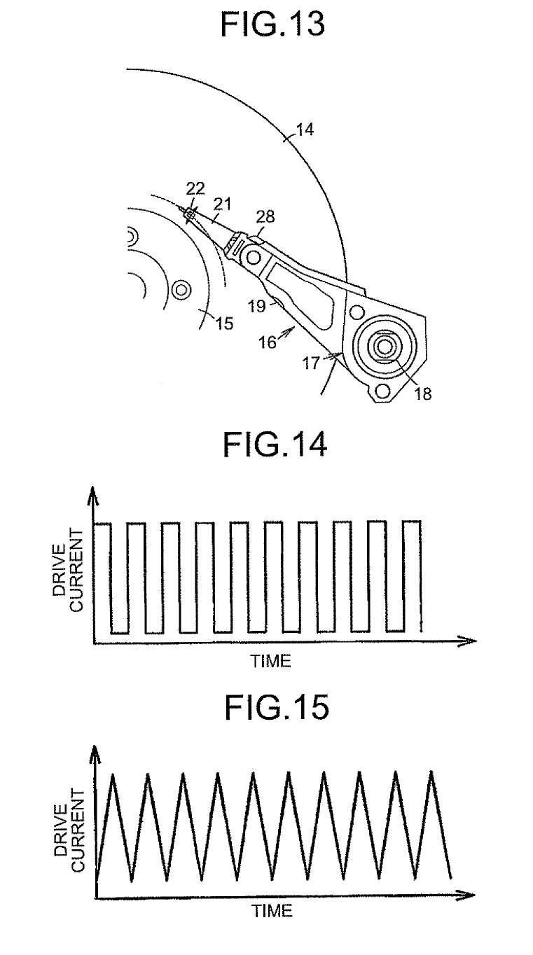

As mentioned earlier, the protrusion 48 moves up and down in the vertical direction perpendicular to the surface of the magnetic disk 14 based on the AC component. As a result, the protrusion 48 is intermittently brought into contact with the surface of the magnetic disk 14. Upon the contact, a frictional force is generated between the protrusion 48 and the magnetic disk 14. The flying head slider 22 is dragged on the surface of the magnetic disk 14. The flying head slider 22 is displaced in the direction off the track. On the contrary, when the protrusion 48 and the magnetic disk 14 are not in contact, because no frictional force is generated, the flying head slider 22 is pulled back to the original position. In this manner, the flying head slider 22 vibrates in the radial direction, i.e., cross-track direction, of the magnetic disk 14. As a result, as illustrated in FIG. 13, the head suspension 21 vibrates in the in-plane direction along the surface of the magnetic disk 14. Because the frequency of the AC component matches the natural frequency of the head suspension 21 in the in-plane direction, the head suspension 21 resonates in the in-plane direction.

At this time, the control circuit 59 observes a change in the positioning error signal. Based on the resonance of the head suspension 21, the electromagnetic transducer device 33 is significantly displaced in the cross-track direction on the targeted recording track. Therefore, the control circuit 59 detects a large phase difference based on a calculation. The positioning error signal, output from the control circuit 59, changes greatly based on the phase difference. In this manner, the control circuit 59 determines contact between the protrusion 48 and the magnetic disk 14. The control circuit 59 then determines the protruding length of the protrusion 48 while the contact is established. The determined protruding length is stored in, for example, the memory. In this manner, the zero calibration is completed.

In the HDD 11 described above, while the zero calibration is being performed, the protrusion 48 moves up and down in a direction perpendicular to the surface of the magnetic disk 14 based on the AC component. As a result, the flying head slider 22 is caused to vibrate along the surface of the magnetic disk 14 based on its contact or non-contact onto the magnetic disk 14. Because the frequency of the AC component matches the natural frequency of the head suspension 21 in the in-plane direction, the head suspension 21 resonates in the in-plane direction. As a result, the positioning error signal changes greatly based on a large phase difference. In this manner, the control circuit 59 can detect the contact between the protrusion 48 and the magnetic disk 14 with high accuracy regardless of the small frictional force.

In the HDD 11, as illustrated in FIG. 14, the AC component may be defined by rectangular waves. Similarly, as illustrated in FIG. 15, the AC component may be defined by triangular waves. The protruding length of the protrusion 48 increases or decreases correspondingly to the AC component having the rectangular or the triangular waves. Furthermore, a lubricant film may be formed on the ABS 42 of the rear center rail 38. When the protrusion 48 and the magnetic disk 14 are in contact, Meniscus is formed between the ABS 42 and the surface of the magnetic disk 14 due to the presence of the lubricant film. The Meniscus causes the frictional force to be produced more easily between the protrusion 48 and the magnetic disk 14.

In the HDD 11, upon detecting the contact between the protrusion 48 and the magnetic disk 14, instead of the positioning error signal, a logarithm of a reproduced output of the binary information may be used. Generally, the flying height FH and the logarithm of the reproduced output are defined approximately in a linear relationship. If the flying height FH decreases, the logarithm of the reproduced output increases linearly. When the flying height FH is reduced to zero due to the contact between the protrusion 48 and the magnetic disk 14, the reproduced output is maximized. The vibration of the flying head slider 22 due to the contact increases the average of the flying height FH. As a result, the reproduced output may decrease. At the same time, if the electromagnetic transducer device 33 shifts in the cross-track direction on a recording track, the reproduced output decreases correspondingly to an increase in the shift. According to the embodiment, because the electromagnetic transducer device 33 is displaced significantly in the cross-track direction on the targeted recording track based on the resonance of the head suspension 21, the reproduced output changes greatly in a degree greater than ever. Therefore, the control circuit 59 may monitor a change in the logarithm of the reproduced output to determine the contact based on the variation in the changing ratio (slope). Alternatively, upon detecting the contact, other parameters representing the quality of reproduction property and having a relationship with the flying height FH, such as signal-to-noise (S/N) ratio, reproduction resolution, signal error rate, half-pulse width (PW50), may be used.

Alternatively, to detect the contact, an acoustic emission (AE) sensor may be incorporated in the HDD 11. The AE sensor is connected to the control circuit 59. The AE sensor can detect a vibration, i.e., elastic wave, of the flying head slider 22 generated due to the contact between the protrusion 48 and the magnetic disk 14. The control circuit 59 detects the contact of the protrusion 48 and the magnetic disk 14 based on the output of the AE sensor. It is preferable to use an AE sensor having a good gain with respect to the natural frequency of the head suspension 21 in the in-plane direction. The AE sensor may be used in combination with the signal detection based on the positioning error signal.

A patterned medium, such as a bit-patterned medium (BPM) or a discrete track medium (DTM), may be used as the magnetic disk 14. In the patterned medium, a recording track for the zero calibration, for example, is formed on the innermost track or the outer most track. A corrugated pattern protruding from the surface is formed on the recording track. The cycle of the corrugation of the corrugated pattern matches the natural frequency of the head suspension 21 in the in-plane direction. When the protrusion 48 is brought in contact with the corrugation on the corrugated pattern, the head suspension 21 resonates in the same manner as described above. At this time, the control circuit 59 detects the contact based on a change in the magnitude of the signal read by the electromagnetic transducer device 33. In this manner, the control circuit 59 can detect the contact with high accuracy as is described above.

As described above, according to an embodiment of the invention, contact between a head slider and a recording medium can be detected with high accuracy.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage device comprising:
a recording medium;
a head slider configured to face a surface of the recording medium;
a head suspension configured to support the head slider;
an actuator in the head slider and configured to increase a protruding length of a protrusion on the head slider toward the surface of the recording medium based on an increase in an electrical signal supplied; and
an alternating current component generator configured to superimpose an alternating current component comprising a frequency substantially equal to a natural frequency of the head suspension over the electrical signal while increasing or decreasing the protruding length of the protrusion at a predetermined amplitude.

2. The storage device of claim 1, wherein the natural frequency is defined in an in-plane direction of the head suspension.

3. The storage device of claim 1, further comprising a detector configured to detect contact between the protrusion and the recording medium based on a change in a signal read from the recording medium by an electromagnetic transducer device in the head slider.

4. The storage device of claim 1, further comprising a detector configured to detect contact between the protrusion and the recording medium based on detection of an elastic wave generated by the contact between the protrusion and the recording medium.

5. A method of determining a head slider contact comprising:
boosting an electrical signal supplied to an actuator in a head slider in order to increase a protruding length of a protrusion on the head slider toward a recording medium;
superimposing an alternating current component comprising a frequency substantially equal to a natural frequency of a head suspension supporting the head slider over the electrical signal when the protruding length of the protrusion increases; and
detecting contact between the protrusion and the recording medium based on a vibration of the head slider induced by the contact between the protrusion and the recording medium.

6. The method of claim 5, wherein the natural frequency is defined in an in-plane direction of the head suspension.

7. The method of claim 5, wherein the contact between the protrusion and the recording medium is detected based on a change in a signal read from the recording medium by an electromagnetic transducer device in the head slider.

8. The method of claim 5, wherein the contact between the protrusion and the recording medium is detected based on an elastic wave due to the contact between the protrusion and the recording medium.
